(19) United States
(12) Patent Application Publication
(10) Pub. No.: US 2023/0334356 A1
(43) Pub. Date: Oct. 19, 2023

(54) QUANTUM CIRCUIT AND QUANTUM COMPUTATION METHOD

(71) Applicant: GRID INC., Tokyo (JP)

(72) Inventors: Masaru Sogabe, Tokyo (JP); Chih-chieh Chen, Tokyo (JP); Kodai Shiba, Tokyo (JP)

(21) Appl. No.: 18/245,339

(22) PCT Filed: May 19, 2021
(86) PCT No.: PCT/JP2021/018939

§ 371 Date: Mar. 14, 2023

Related U.S. Application Data
(60) Provisional application No. 63/078,674, filed on Sep. 15, 2020.

(51) Int. Cl. G06N 10/20

(52) U.S. Cl. CPC G06N 10/20

(57) ABSTRACT

Provided is a quantum circuit for solving a problem in a partially observable Markov decision process, which includes a plurality of first unitary gates U⁰, U¹, ..., U^{q} applied to an initial state including n qubits in order, and a plurality of second unitary gates α⁰, α¹, ..., a^{q+1} applied to one qubit in a |0>state in order, wherein U^{q} is controlled by a qubit output from α^{q}, and after computation by the first unitary gates and the second unitary gates is performed, the states of the n qubits are observed to confirm the state of each qubit in order to set a final state.

### CROSS-REFERENCE TO RELATED APPLICATION

This application is based on U.S. Provisional Pat. Application No. 63/078,674, filed Sep. 15, 2020, the entire contents of which are incorporated herein by reference.

### TECHNICAL FIELD

The present invention relates to a quantum circuit and a quantum computation method.

### BACKGROUND ART

Quantum computers have been proposed as one of the ways to achieve an information processing capacity exceeding classic computers, and algorithms for solving various problems using quantum computers have been actively studied.

A Markov decision process is known as a framework for making the best decisions under dynamically changing conditions. Particularly, under circumstances where environmental information cannot be observed perfectly like robot control, a partially observable Markov decision process (POMDP) is used.

The ideas of quantum mechanics have in common with control problems treated in the partially observable Markov decision process in that a quantum state can not be directly observed without collapsing a wave function by measurements. For this reason, a method of treating an optimization control problem involved in designing quantum gates as the POMDP problem has been considered in recent years (for example, Non-Patent Document 1). However, a specific POMDP model to be implemented on a quantum computer has not been proposed yet.

### Citation List

### Non-Patent Document

Non-Patent Document 1: Jennifer Barry, Daniel T. Barry, and Scott Aaronson, “Quantum partially observable Markov decision processes” Phys. Rev. A 90, 032311(2014)

### SUMMARY

Therefore, it is an object of the present invention to solve a problem in a partially observable Markov decision process by a quantum algorithm.

A quantum circuit according to one aspect of the present invention is a quantum circuit for solving a problem in a partially observable Markov decision process, the quantum circuit including: a plurality of first unitary gates U⁰, U¹, ..., U^{q} applied to an initial state including n qubits in order; and a plurality of second unitary gates α⁰, α¹, ..., a^{q+1} applied to one qubit in a |0> state in order, wherein U^{q} is controlled by a qubit output from a^{q}, and after computation by the first unitary gates and the second unitary gates is performed, the states of the n qubits are observed to confirm the state of each qubit in order to set a final state.

A quantum circuit according to one aspect of the present invention is a quantum circuit for solving a problem in a partially observable Markov decision process, the quantum circuit including: a plurality of first unitary gates U⁰, U¹, ..., U^{q} applied to an initial state including n qubits in order; and a plurality of second unitary gates α⁰, α¹, ..., α^{2q+1} applied to q+1 qubits in a |0>state, wherein α^{q-1} and α^{2q} are applied to the q-th qubit in the |0>state in order, U^{q} is controlled by a qubit output from α^{q}, and after computation by the first unitary gates and the second unitary gates is performed, the states of the n qubits are observed to confirm the state of each qubit in order to set a final state.

A quantum computation method according to one aspect of the present invention is a quantum computation method for solving a problem in a partially observable Markov decision process, the quantum computation method including: applying a plurality of first unitary gates U⁰, U¹, ..., U^{q} to an initial state including n qubits in order; applying a plurality of second unitary gates α⁰, α¹, ..., α^{q+1} to one qubit in a |0>state in order; connecting U^{q} to a qubit output from a^{q}; and after computation by the first unitary gates and the second unitary gates is performed, observing the states of the n qubits to confirm the state of each qubit in order to set a final state.

A quantum computation method according to one aspect of the present invention is a quantum computation method for solving a problem in a partially observable Markov decision process, the quantum computation method including: applying a plurality of first unitary gates U⁰, U¹, ..., U^{q} to an initial state including n qubits in order; including a plurality of second unitary gates α⁰, α¹, ..., α^{2q+1} for q+1 qubits in a |0>state; applying a^{q-1} and a^{2q} to the q-th qubit in the |0>state in order; connecting U^{q} to a qubit output from a^{q}, and after computation by the first unitary gates and the second unitary gates is performed, observing the states of the n qubits to confirm the state of each qubit in order to set a final state.

### Advantageous Effects of Invention

According to the present invention, the problem in the partially observable Markov decision process can be solved by a quantum algorithm.

### BRIEF DESCRIPTION OF DRAWINGS

FIG. 1 is a diagram illustrating a quantum circuit 1 according to one embodiment of the present invention.

FIG. 2 is a diagram illustrating a quantum circuit 2 according to one embodiment of the present invention.

FIG. 3 is a table illustrating the definitions of transition matrices in a partially observable Markov decision process.

FIG. 4 is a diagram illustrating the relationships among the respective transition matrices in the partially observable Markov decision process.

FIG. 5 is a diagram illustrating a quantum circuit for computing a doubly stochastic matrix in the partially observable Markov decision process.

FIG. 6 is a diagram illustrating a problem in the partially observable Markov decision process that can be computed by using the quantum circuit 1, 2 according to one embodiment of the present invention.

FIG. 7 is a diagram illustrating an example of a quantum circuit according to one embodiment of the present invention.

FIG. 8 is a diagram illustrating the schematic configuration of an information processing apparatus 100 in which a quantum circuit according to one embodiment of the present invention is implemented.

### DESCRIPTION OF EMBODIMENTS

Embodiments of the present invention will be described in detail below with reference to the accompanying drawings.

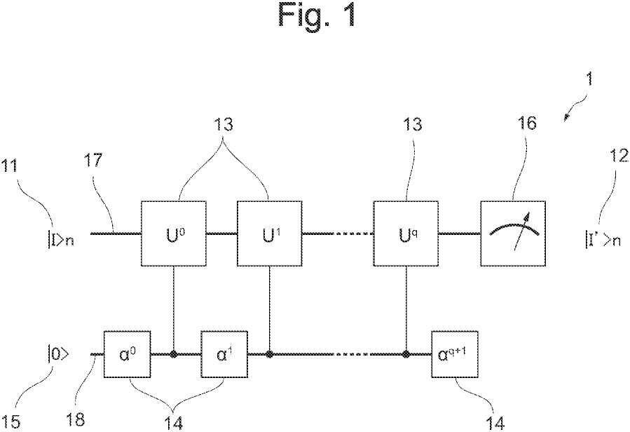

FIG. 1 is a diagram illustrating a quantum circuit 1 according to one embodiment of the present invention. The quantum circuit 1 is a series quantum circuit acting on an initial state |l>ₙ 11 of n qubits to get the solution of an optimization problem using a partially observable Markov decision process as a final state |l′>ₙ 12. Each of the initial state |l>ₙ 11 and the final state |l′>ₙ 12 is a result of the superposition of a quantum state “1” or “0” of the n qubits. The quantum circuit 1 is implemented in a quantum computer 200 of a computer system 10 to be described later. The computer system 10 is a hybrid system having a classic computer function and a quantum computer function to execute a quantum algorithm in order to get the solution of the optimization problem using the partially observable Markov decision process by causing a classic computer 100 and the quantum computer 200 to interact with each other.

In FIG. 1, U⁰, U¹, ..., U^{q} 13 (first unitary gates) are applied to |I>ₙ 11, which are specifically CNOT gates applied, for example, to two qubits. Further, α⁰, α¹, ..., α^{q+1} 14 (second unitary gates) are applied to an input state |0> 15 (one qubit of state “0”), which are specifically rotation gates applied, for example, to a single qubit. Each of the CNOT gates is a gate having a function in which, when one qubit (control bit) is “1,” the other qubit (target bit) is inverted. Each of the rotation gates applies a unitary matrix to a certain quantum state to perform computation so as to change the quantum state to another quantum state. As illustrated in FIG. 1, U⁰, U¹, ..., U^{q} 13 are made to act on the initial state |I>ₙ 11 in order, and after performing computation to make α⁰, α¹, ..., α^{q+1} 14 act on the input state |0> 15 in order, an observation 16 of the states of the n qubits is made to confirm the state of each bit (0 or 1) in order to set the final state |l′>ₙ 12. Further, U^{q} is connected to a wire 18 between α^{q} and α^{q+1}

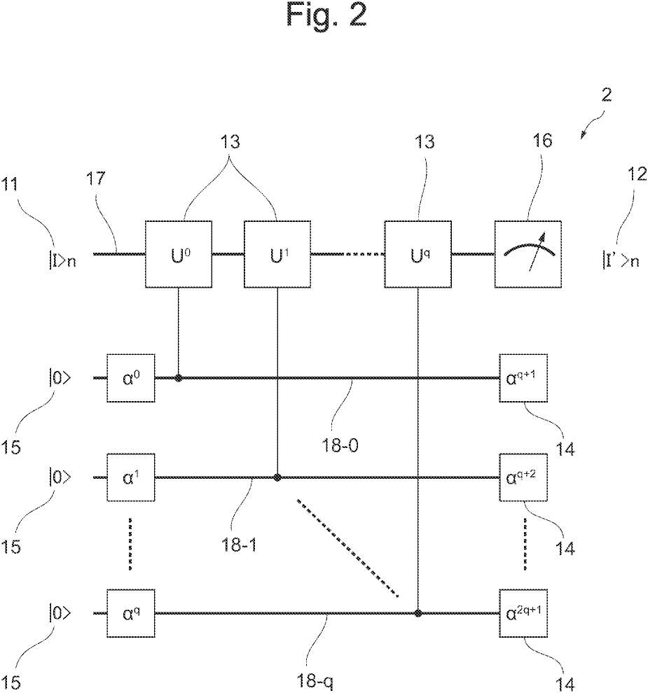

FIG. 2 is a diagram illustrating a quantum circuit 2 that acts on the initial state |l>ₙ 11 of n qubits like in FIG. 1 to get the solution of the optimization problem using the partially observable Markov decision process as the final state |l′ >ₙ 12. The quantum circuit 2 is a parallel circuit. Like the quantum circuit 1, the quantum circuit 2 is also a quantum circuit implemented in the quantum computer 200 of the computer system 10 to be described later to realize a quantum algorithm in order to get the solution of the optimization problem using the partially observable Markov decision process through the interaction with the classic computer 100. In FIG. 2, U⁰, U¹, ..., U^{q} 13 (first unitary gates) are applied to |l>ₙ 11, which are specifically CNOT gates applied, for example, to two qubits. Further, α⁰, α¹, ..., α^{2q+1} 14 (second unitary gates) are applied to q+1 input states |0> 15 (one qubit of state “0”), which are specifically rotation gates applied, for example, to a single qubit. As illustrated in FIG. 2, the quantum circuit 2 is the same as the quantum circuit 1 in FIG. 1 in that U⁰, U¹, ..., U^{q} 13 are made to act on the initial state |l>ₙ 11 in order. On the other hand, α⁰, α¹, ..., α^{2q+1} 14 are made to act on the q+1 input states |0>15 arranged in parallel to one another. After performing respective computations, an observation 16 of the states of the n qubits is made to confirm the state of each bit (0 or 1) in order to set the final state |l′ >ₙ 12. Further, U^{q} is connected to a wire 18-q between α^{q} and α^{2q+1}.

A Markov decision process is a decision making process in which elements of “actions” taken by an agent while interacting with an environment and “rewards” given to the agent are added to a state transition process in a Markov chain. On the other hand, since many problems in the real world are so restricted that the agent cannot directly observe the entire environment, the problems are treated as the problems in the partially observable Markov decision process. In the partially observable Markov decision process, there is a need to store the actions by the agent and the history of observations or to infer the state. Further, like in the Markov decision process, any problem in the partially observable Markov decision process can be solved by using dynamic programming and a reinforcement learning algorithm.

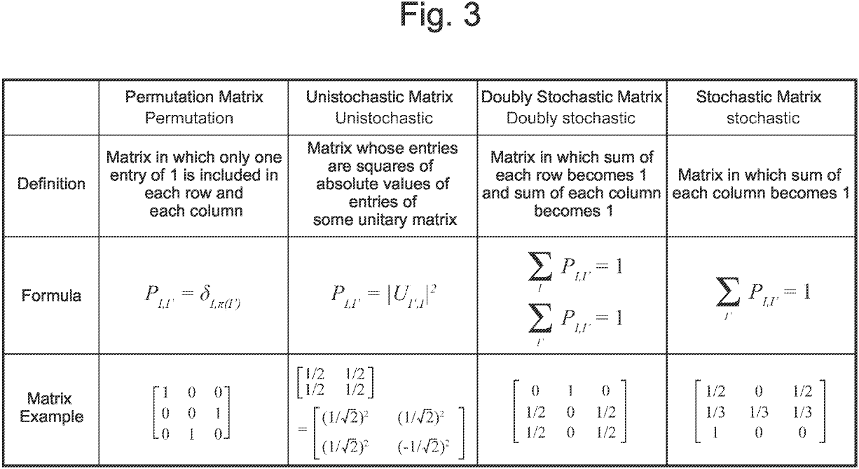

FIG. 3 is a table illustrating the definitions of transition matrices in the partially observable Markov decision process (permutation matrix, unistochastic matrix, doubly stochastic matrix, stochastic matrix), corresponding formulas, and matrix examples. Each of the transition matrices illustrated in FIG. 3 is basically a stochastic matrix. The stochastic matrix is a matrix in which the sum of each row becomes 1. Further, the permutation matrix is a unitary matrix in which only one entry of “1” is included in each row and each column, and the other entries are all “0.” The unistochastic matrix is a matrix whose entries are the squares of the absolute values of the entries of some unitary matrix, and the doubly stochastic matrix is a matrix in which the sum of each row and each column becomes 1 and a transpose of the matrix also becomes a stochastic matrix.

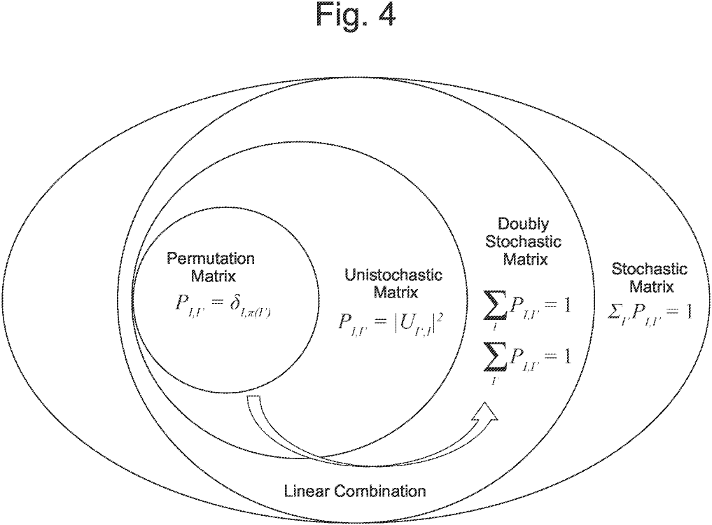

FIG. 4 is a diagram illustrating the relationships among the respective transition matrices (permutation matrix, unistochastic matrix, doubly stochastic matrix, and stochastic matrix). As illustrated in FIG. 4, the set of permutation matrix is a subset of the set of unistochastic matrix, the set of unistochastic matrix is a subset of the doubly stochastic matrix, and the set of doubly stochastic matrix is a subset of the set of stochastic matrix.

As for the unistochastic matrix, it is known that it can be computed by a quantum circuit (Reference Document 1). As for the doubly stochastic matrix (without including any unistochastic matrix), a specific building method thereof using a quantum circuit is unknown. On the other hand, it is known from the Birkhoff-von Neumann theorem that any doubly stochastic matrix can be formed by a linear combination of permutation matrices.

[Reference Document 1] Shende et al, arXiv: quant-ph/0406176, Iten et al., Phys. Rev. A 93, 032318 (2016) arXiv:1501.06911 [quant-ph], arXiv:1904.01072

For example, the left side of Equation (1) below illustrates an example of a 4×4 doubly stochastic matrix P. Note that the matrix P in Equation (1) is not the unistochastic matrix. The matrix P can be decomposed as illustrated on the right side of Equation (1). The first matrix on the right side is a matrix corresponding to a SWAP gate, and the second matrix is a matrix corresponding to a CNOT gate.

$$\left(\begin{matrix}1 & 0 & 0 & 0 \\ 0 & \frac{1}{2} & \frac{1}{2} & 0 \\ 0 & \frac{1}{2} & 0 & \frac{1}{2} \\ 0 & 0 & \frac{1}{2} & \frac{1}{2}\end{matrix}\right) = \frac{1}{2} \left(\begin{matrix}1 & 0 & 0 & 0 \\ 0 & 0 & 1 & 0 \\ 0 & 1 & 0 & 0 \\ 0 & 0 & 0 & 1\end{matrix}\right) + \frac{1}{2} \left(\begin{matrix}1 & 0 & 0 & 0 \\ 0 & 1 & 0 & 0 \\ 0 & 0 & 0 & 1 \\ 0 & 0 & 1 & 0\end{matrix}\right) \qquad \text{[Math 1]}$$

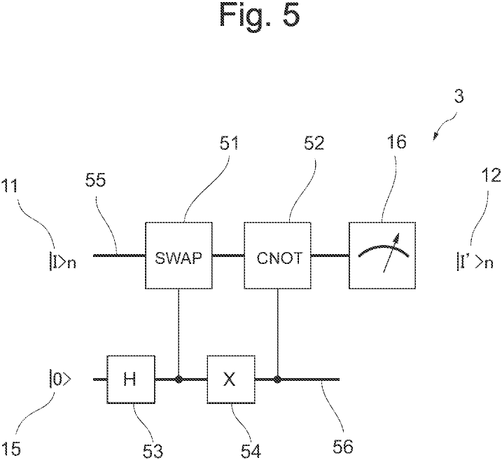

Therefore, the doubly stochastic matrix P can be computed by using a quantum circuit 3 illustrated in FIG. 5 in consideration of Equation (1) above. In the example of FIG. 5, U⁰ and U¹ in FIG. 1 correspond to a SWAP gate 51 and a CNOT gate 52, respectively, and α⁰ and α¹ correspond to a Hadamard gate H 53 and a NOT gate X 54, respectively. The SWAP gate has a function to replace values (states) of two qubits. In the example of FIG. 5, the values of a wire 55 and a wire 56 are replaced. The CNOT gate has a function in which when one qubit (control bit) is “1,” the other qubit (target bit) is inverted. In the example of FIG. 5, the wire 55 side is the target bit and the wire 56 side is the control bit. The Hadamard gate H 53 has a function to act on the input state |0> 15 to make the state into a superimposed state of |0> or |1>.

Specifically, the quantum circuit 1 in FIG. 1 computes a linear combination of matrices expressed in Equation (2) below. Equation (2) has a structure in which the squares of linear combinations of unitary matrices U⁰...U^{q} are included inside the linear combinations of matrices α⁰...α^{q+1}. Here, each of the matrices U⁰...U^{q} can be regarded as a permutation matrix in the transition matrices. Thus, the quantum circuit 1 is a quantum circuit to perform computations by decomposing the doubly stochastic matrix P into a linear combination of permutation matrices. Such computations of the doubly stochastic matrix P require a computation time in the order of O(2ⁿ) on a classic computer. On the other hand, according to the quantum circuit 1, the time required for computations becomes a polynomial time.

$${P}_{I , t r} = {\sum }_{k} {\left|{\sum }_{{c}_{0} {c}_{1} … {c}_{q}} {α}_{k {c}_{q}}^{2} … {α}_{{c}_{1} {c}_{0}}^{1} {α}_{{c}_{0} 0}^{0} \left〈{I}^{′}\right| {\left({U}^{q}\right)}^{{c}_{q}} … {\left({U}^{1}\right)}^{{c}_{1}} {\left({U}^{0}\right)}^{{c}_{0}} \left|I\right〉\right|}^{2} \qquad \text{[Math 2]}$$

Further, the quantum circuit 2 in FIG. 2 computes a linear combination of matrices specifically expressed in Equation (3) below. Like Equation (2), Equation (3) has a structure in which the squares of linear combinations of unitary matrices U⁰...U^{q} are included inside the linear combinations of matrices α⁰...α^{2q+1}. Here, each of the matrices U⁰...U^{q} can be regarded as a permutation matrix in the transition matrices. Thus, the quantum circuit 2 is a quantum circuit to perform computation by decomposing the doubly stochastic matrix P into linear combinations of permutation matrices.

$$\begin{matrix}{P}_{I , I r} \\ = {\sum }_{{k}_{0} {k}_{1} … {k}_{q}} \left|{\sum }_{{c}_{0} {c}_{1} … {c}_{q}} {α}_{{k}_{q} {c}_{q}}^{2 q} {α}_{{c}_{q} 0}^{q} … {α}_{{k}_{1} {c}_{1}}^{q + 2} {α}_{{c}_{1} 0}^{q + 1} {α}_{{k}_{0} {c}_{0}}^{q + 1} {α}_{{c}_{0} 0}^{0} \left〈{I}^{′}\right| {\left({U}^{q}\right)}^{{c}_{q}} …\right) \\ {\left({\left({U}^{1}\right)}^{{c}_{1}} {\left({U}^{0}\right)}^{{c}_{0}} \left|I\right〉\right|}^{2}\end{matrix} \qquad \text{[Math 3]}$$

As described above, according to the embodiment, the doubly stochastic matrix (not including any unistochastic matrix) can be computed by a quantum circuit that constructs a linear combination of permutation matrices among transition matrices in the partially observable Markov decision process.

### Example

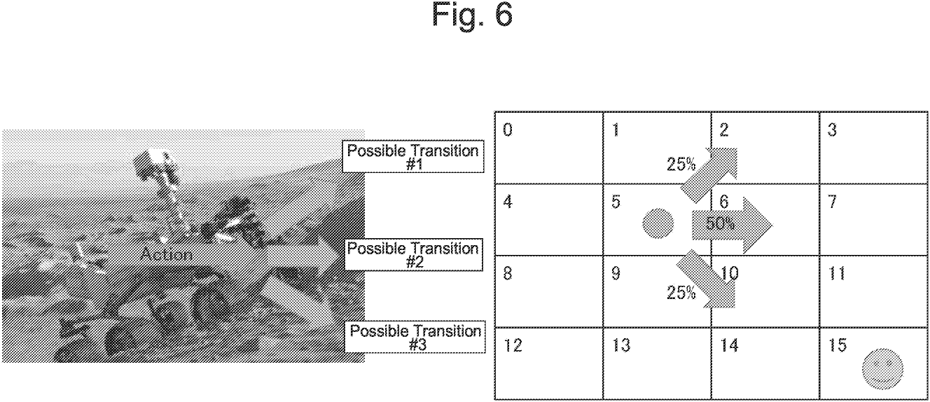

FIG. 6 is a diagram illustrating a problem in the partially observable Markov decision process that can be computed by using the quantum circuit 1, 2 according to the present embodiment. In the example of FIG. 6, it is assumed to be applied to the movement control of a Mars exploration robot. Specifically, it can be treated as a problem in a decision making process when the robot (agent) moves on 4×4 grids. For example, the robot moves from the current position in a straight direction (50%), in a left oblique direction (25%), or a right oblique direction (25%). Part of FIG. 6 is quoted from the Internet (https://www.nationalgeographic.com/news/2012/8/120806-mars-landing-curiosity-rover-nasa-jpl-science/).

In such movement control of the robot, when the robot selects one action (which direction to go), the state may transition to a new state depending on the environment (a landscape, wind direction and strength, and the like). For example, when the robot moved to the right, there is a possibility that the ground of the destination may be distorted and the robot may result in going to a location different from an intended location. Such a model is an example of the problem in the partially observable Markov decision process in terms of the fact that the agent (robot) cannot directly observe the entire environment.

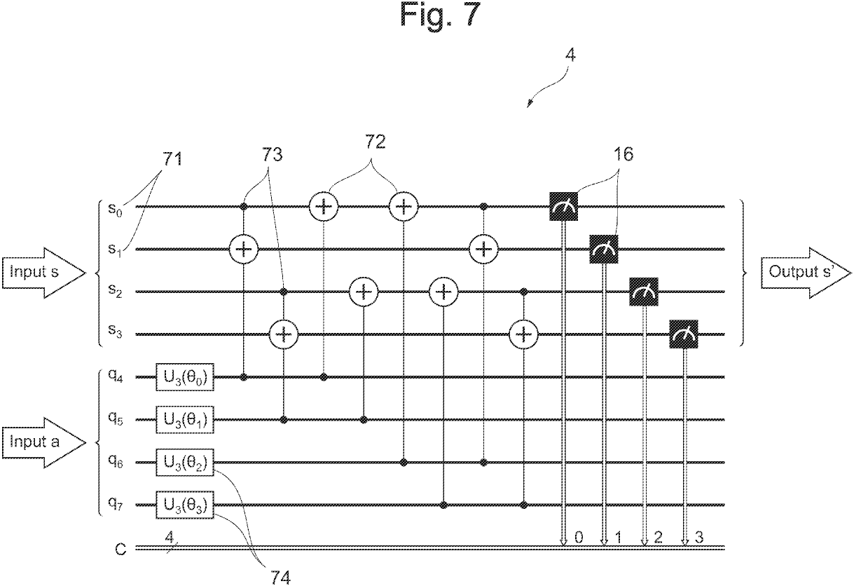

FIG. 7 is a diagram illustrating an example of a quantum circuit (quantum circuit 4) for solving the problem in the partially observable Markov decision process illustrated in FIG. 6. As illustrated in FIG. 7, CNOT gates 72, each of which is composed of one control bit and one target bit, or CCNOT gates 73 each of which is composed of two control bits and one target bit are made to act on input qubits 71 (S₀ to S₃) to make observations 16. Further, rotation gates U₃(θ₀) to U₃(θ₃) 74 are applied to input qubits (a₄ to a₇), respectively. In each of θ₀ to θ₃, an angle (such as 0, π/2, or π) according to the direction of travel of the agent is set.

### Hardware Configuration

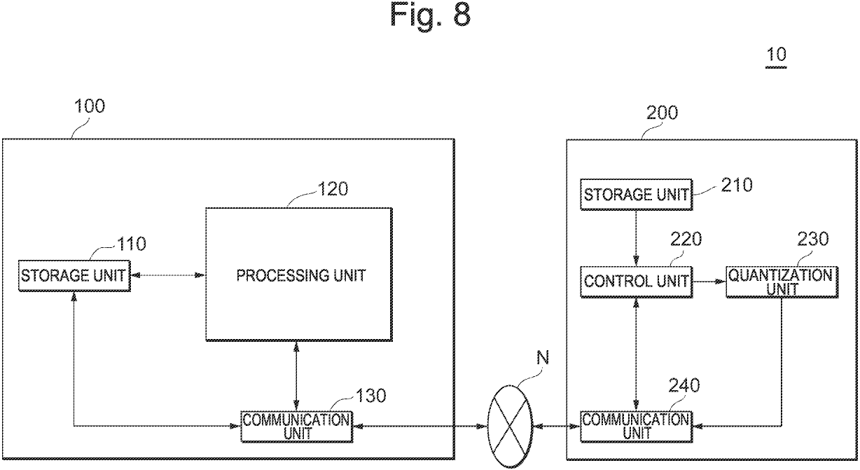

FIG. 8 is a diagram illustrating a configuration example of the computer system 10 to implement a quantum circuit according to the present invention. The computer system 10 includes the classic computer 100 and the quantum computer 200. Therefore, the computer system 10 is configured as a hybrid system having the classic computer function and the quantum computer function. The classic computer 100 and the quantum computer 200 are connected communicably through a communication network N. The communication network N is a wired or wireless communication network such as the Internet or LAN (Local Area Network).

The classic computer 100 executes a classic program to perform various information processing. The classic program is code representing an algorithm executable by the classic computer. The classic program is a program written in a programming language such as C language. The classic computer 100 includes a storage unit 110, a processing unit 120, and a communication unit 130.

The storage unit 110 stores various information. Specifically, the storage unit 110 stores the classic program used by the processing unit 120 to execute various processing, information to be processed by the processing unit 120, the results of processing by the processing unit 120, and information such as data generated by the quantum computer 20. The various information stored in the storage unit 110 is referred to by the processing unit 120 as required.

The processing unit 120 has a function to perform various information processing. Further, the processing unit 120 can store the processing results in the storage unit 110.

The communication unit 130 can send and receive various information. The communication unit 130 can send, to the quantum computer 200, data generated by the processing unit 120. Further, the communication unit 130 can receive the execution results of a quantum computing algorithm by the quantum computer 200. Further, the communication unit 130 can store the received information in the storage unit 110.

The quantum computer 200 is a computer for performing computations using quantum mechanical properties of matter, which may be a quantum gate-type quantum computer. The quantum computer 200 may be configured by any hardware.

The quantum computer 200 can execute a quantum computing algorithm based on a quantum program. The quantum program is code representing various quantum algorithms. For example, the quantum program may be represented as the quantum circuit according to the present invention. Note that the quantum program may include a program written in a programming language like the classic program.

The quantum computer 200 includes a storage unit 210, a control unit 220, a quantization unit 230, and a communication unit 240. Here, the storage unit 210, the control unit 220, and the communication unit 240 may include classic computer functions.

The storage unit 210 stores various information. For example, the storage unit 210 stores the quantum program used by the quantization unit 230 to execute a quantum computing algorithm. The various information stored in the storage unit 210 is referred to by the control unit 220 as required.

The control unit 220 can control the quantization unit 230 based on the quantum program. Specifically, the control unit 220 can cause the quantization unit 230 to execute a quantum computing algorithm based on feature data corresponding to parameters generated by the processing unit 120 and input data.

The quantization unit 230 is a core part of the quantum computer 200, which can execute the quantum computing algorithm under the control of the control unit 220.

The communication unit 240 has a function to send and receive various information. For example, the communication unit 240 sends the execution results by the quantization unit 230 to the classic computer 10.

Optimization control problems involved in the design of conventional quantum gates depended on the classic model and the classic simulation. Since the quantum Hilbert space has an exponential magnitude, it was difficult to apply the classic model method to a large-scale quantum computer system. However, an optimization method capable of scaling more qubits more properly can be developed by treating the optimization method as the problem in the partially observable Markov decision process as in the present invention. In other words, even when the Hilbert space becomes exponentially large, it can be expected that the sample computational complexity will be fit in a polynomial time. According to the present invention, a design method of a specific quantum circuit in the optimization control problem and a quantum computation method can be provided.

Note that the present invention is not limited to the embodiments described above, and the present invention can be carried out in various other forms without departing from the scope of the present invention. Therefore, the above embodiments are just examples in all respects, and not to be interpreted restrictively.

### REFERENCE SIGNS LIST

1, 2, 3, 4...quantum circuit, 11...initial state, 12...final state, 13...first unitary gate, 14...second unitary gate, 15...input state, 16...observation, 17, 18, 18-0 to 18-q...wire, 51...SWAP gate, 52...CNOT gate, 53...Hadamard gate H, 54...NOT gate X, 55, 56...wire, 71...input qubit, 72...CNOT gate, 73...CCNOT gate, 74..rotation gate, 10...computer system, 100...classic computer, 110...storage unit, 120...processing unit, 130...communication unit, 200...quantum computer, 210...storage unit, 220...control unit, 230...quantization unit, 240...communication unit.

What is claimed is:

1. A quantum circuit for solving a problem in a partially observable Markov decision process, comprising:
a plurality of first unitary gates U⁰, U¹, ..., U^{q} applied to an initial state including n qubits in order; and
a plurality of second unitary gates α⁰, α¹, ..., α^{q+1} applied to one qubit in a |0> state in order, wherein
U^{q} is controlled by a qubit output from α^{q}, and
after computation by the first unitary gates and the second unitary gates is performed, states of the n qubits are observed to confirm a state of each qubit in order to set a final state.

2. A quantum circuit for solving a problem in a partially observable Markov decision process, comprising:
a plurality of first unitary gates U⁰, U¹, ..., U^{q} applied to an initial state including n qubits in order; and
a plurality of second unitary gates α⁰, α¹, ..., a^{2q+ 1} applied to q+1 qubits in a |0>state, wherein
α^{q}_{¯}¹ and α^{2q} are applied to the q-th qubit in the |0>state in order,
U^{q} is controlled by a qubit output from α^{q}, and
after computation by the first unitary gates and the second unitary gates is performed, states of the n qubits are observed to confirm a state of each qubit in order to set a final state.

3. The quantum circuit according to claim 1 or 2, wherein the first unitary gates are CNOT gates.

4. The quantum circuit according to any one of claims 1 or 2, wherein the second unitary gates are rotation gates.

5. The quantum circuit according to any one of claims 1 or 2, wherein the plurality of first unitary gates correspond to permutation matrices, and a sample of a doubly stochastic matrix is obtained as the final state.

6. A quantum computation method for solving a problem in a partially observable Markov decision process, comprising:
applying a plurality of first unitary gates U⁰, U¹, ..., U^{q} to an initial state including n qubits in order;
applying a plurality of second unitary gates α⁰, α¹, ..., α⁹⁺¹ to one qubit in a |0>state in order;
connecting U^{q} to a qubit output from α^{q}; and
after computation by the first unitary gates and the second unitary gates is performed, observing states of the n qubits to confirm a state of each qubit in order to set a final state.

7. A quantum computation method for solving a problem in a partially observable Markov decision process, comprising:
applying a plurality of first unitary gates U⁰, U¹, ..., U^{q} to an initial state including n qubits in order;
including a plurality of second unitary gates α⁰, α¹, ..., α^{2q+1} for q+1 qubits in a |0>state;
applying α^{q}_{¯}¹ and α^{2q} to the q-th qubit in the |0>state in order;
connecting U^{q} to a qubit output from α^{q}, and
after computation by the first unitary gates and the second unitary gates is performed, observing states of the n qubits to confirm a state of each qubit in order to set a final state.
